(19) United States
(12) Patent Application Publication
(10) Pub. No.: US 2004/0080624 A1
(43) Pub. Date: Apr. 29, 2004

(54) Universal dynamic video on demand surveillance system

(76) Inventor: Siltex Peter Yuen, San Jose, CA (US)

Correspondence Address: Siltex Peter Yuen, 2765 Henessy Drive, San Jose, CA, 95148, US

(21) Appl. No.: 10/282,995

(22) Filed: Oct. 29, 2002

(51) Int. Cl. H04N 7/173

(52) U.S. Cl. 348/211.99; 725/105

(57) ABSTRACT

An Universal Dynamic Video On Demand Surveillance System is a mass video surveillance system with affordable price. It allows users to have global access to the installed sites and with multiple users at the same time. Users can use generic personal video camcorder or camera instead of expensive industrial surveillance camera. Users can have full control of the camera pan and tilt positions and all the features of the video camera from any part in the world as long as Internet access is available. Furthermore, the users can retrieve the video and audio data and watch it on the monitor screen instantly.

This new invention is also a dynamic video on demand video-telephone conferencing system. It allows the users to search, zoom and focus around all the meeting rooms at wish.

### FIELD OF INVENTION

The present invention relates generally to surveillance system, and more particularly to remote control video and audio surveillance network system.

### BACKGROUND OF THE INVENTION

Surveillance security system has played a very important role in today's world. Since the attack of the World Trade Center, all civilized societies demand for more and more security control in both government and private sectors. Video and audio surveillance are the most basic and are the biggest demand in the industries. Furthermore, much more sophisticated network systems are also required to satisfy today and future needs.

Quality video surveillance equipments are also very expensive. The security surveillance industries need a line of low cost but high quality video equipment such that the users can have more choices.

Thus there is a need for a complete line of low cost surveillance video and audio system with a lot of choices to satisfy every user's requirement. These equipments must be easy to be integrated into both basic and sophisticated surveillance systems. In addition there is an urgent need of video/audio surveillance network such that this network system is low cost, massive, easy to access, easy to control, fast in communication, global and secure from theft and hackers.

All the video, audio and control signals are bundled together and transmitted through data channels and lines. This is much more cost effective than coaxial video and audio cables in most of the surveillance systems.

Furthermore, most remote surveillance systems are static. Users can only watch picture data submitted by the video capturing stations and cannot demand for continuous changing of view or focus and receive the image feedback instantly. This invention provides the dynamic instant control capability and responses to the users.

The present invention provides such a dynamic video/audio global surveillance network system.

CROSS REFERENCE TO RELATED APPLICATIONS

| Field of Search | |
|---|---|
| International Class: | H04N 007/14, 007/18; H04M 011/00 |
| US Class | 348/14.01, 14.05, 14.09, 143, 211.8, 211.11, 211.12 |

U.S. Patent Documents

| 6462774 | Oct. 8, 2002 | Bildstein | 384/143 |
|---|---|---|---|
| This patent is of a surveillance system monitoring local signals. | | | |
| 6166763 | Dec. 26, 2000 | Rhodes | 348/143 |
| This patent is of a local video security system with recording | | | |
| management. | | | |
| 5774569 | Jun. 30, 1998 | Waldenmaier | 382/100 |
| This patent is of a surveillance component to be used in optical | | | |
| system. | | | |
| 5517236 | May 14, 1996 | Sergeant | 348/143 |
| This patent is a local surveillance system working with a specific | | | |
| camera and not any generic camera available in the market. | | | |
| 5886738 | Mar. 23, 1999 | Hollenbeck | 348/151 |
| This patent is a local surveillance system working with a specific | | | |
| camera and not any generic camera available in the market. | | | |
| 6151490 | Nov. 21,2000 | Schultheiss | 455/403 |
| This patent is not a video on demand teleconferencing system. | | | |
| 5835130 | Nov. 10, 1998 | Read | 348/14.11 |
| This patent is a static on hold feature add-on to a telephone system. | | | |
| 5936945 | Aug. 10, 1999 | Shibata | 370/260 |
| This patent is not a video on demand teleconferencing system. | | | |
| 20020097322 | Jul. 25, 2002 | Monroe | 343/159 |

This patent application is of system with static cameras and not
dynamic video on demand method.

### SUMMARY OF THE INVENTION

An universal video/audio surveillance network system that utilizes the latest technology of remote-control utility mounting device, remote-control generic video camera device, compressed bundle signal transmission technique via Internet communication and advance software development of multimedia computer display and control programs.

The unique feature of this invention is the utilization of available generic video camera to perform the video data taking and the built in microphone of the video camera to capture the audio signals. External microphone can also be used to adapt to the video camera. The available handheld video cameras in the market are much more cost effective than industrial line of surveillance camera and with much better features such as high zoom power, fast auto focusing response, low light intensity filming, digital data recording and stereo sound and so on.

The system is comprised of the component stage, (NS) node system stage, (LAVSN) local area video surveillance network stage, Internet stage, (WC) web computer stage and security protection stage.

The component stage consists of the robotic video station system, the bundled signal transmitter and the signal receiver.

The (NS) node system stage includes all the component stage equipment connected to the computer with specially developed software.

The (LAVSN) local area video surveillance network stage includes one or more node system linked together. This can also be a video surveillance network resided in an Intranet system.

The Internet stage consists of at least one LAVSN connecting to a server station, a WC or another LAVSN via the Internet.

The security protection stage consists of all the components of the Internet stage or LAVSN stage with a security protection server also connected to the Internet or the particular LAVSN. The security protection server will verify each user before authorizing the communication processes between node systems; and can also enhance the system by serving as the centralized data storage and backup system.

This basic video retrieval surveillance system allows the user to be able to control and retrieve data from a robotic video camera system through the internet. The user can control his video surveillance system installed at home by virtually using a computer connecting to Internet from any place in the world. Furthermore, he can watch the video picture and listen to the audio sound of his home in the multimedia screen display in his present computer instantly. He can also perform rotate and tilt of the camera mounting stage and zooming function of the video camera by keyboard input to his present computer.

The global video on demand surveillance system allows multiple users to perform the basic video retrieval system at the same time via Internet or Intranet. It can also be used as a video conferencing system with the users can control the camera in every meeting room such that the users can focus and zoom in at wish to watch whatever is in any of the attending conference room plus any NS in the community network system.

The high security system protects the data by providing backup, access authorization check, hacker and theft deterrent to all the above video surveillance systems.

Other features and advantages of the invention will appear from the following description in which the preferred embodiments have been set forth in detail, in conjunction with the accompanying drawings.

### BRIEF DESCRIPTION OF THE DRAWINGS

FIG. 1 is the overall diagram of the complete Universal Dynamic Video On Demand Surveillance Network System. It depicts the three LAVSN systems, the Internet connection, server, and web computer systems according to present invention.

FIG. 2 is the illustration of a conventional computer station setup with special software installed and showing the multimedia screen, keyboard and pointing devices.

FIG. 3 is the illustration of a Web computer of PC handheld, PDA or dash mounted type setup showing the multimedia screen with hard keys, virtual soft keys and pointing devices. A pair of speakers is connected to the system.

FIG. 4 is the illustration diagram of a typical NS node system according to present invention.

FIG. 5 is the illustration diagram of a typical LAVSN local area video surveillance network system according to present invention.

FIG. 6 is the illustration diagram of the communication between 2 LAVSN systems, a server and a web computer system through Internet connection according to present invention.

FIG. 7 is the retrieval process flow chart of direct communication between a Web computer (WC) system and node station (NS) system.

FIG. 8 is the retrieval communication flow chart between two node station (NS) systems within a LAVSN system.

FIG. 9 is the retrieval communication flow chart between two node station (NS) systems of 2 LAVSN systems via Internet.

FIG. 10 is the signal communication flow chart between the video camera, remote control camera mount and the computer I/O data connector via the IR (infrared) transmission method.

FIG. 11 is the signal communication flow chart between the video camera, remote control camera mount and the computer I/O data connector via the RF (radio frequency) transmission method.

### DETAILED DESCRIPTION OF THE PREFERRED EMBODIMENT

Nomenclature

| | |
|---|---|
| LAVSN = | Local Area Video Surveillance Network |
| NS = | Node Station |
| VBCS = | Video Base Computer Station |
| VS = | Video Station |
| TNS = | Terminal Node Station |
| MW = | Multimedia Window Display |
| WC = | Web Computer |
| Connecting System 28 = | This is the connecting system between VBCS |
| | systems. It can be direct cable connection, |
| | fiber optic connection, wireless connection, |
| | Infrared connection or any other connection |
| | system which can facilitate the data connection |
| | mean between the VBCS systems. |
| Connecting System 29 = | This is the connecting system from VBCS, |
| | WC, Server, Main frame computer to the |
| | Internet. It can be dial up modem, DSL, cable, |
| | T1, ISDN,fiber optic, satellite,wireless |
| | or any other connection system which can |
| | facilitate as the connection means |
| | to the Internet from each station. |
| Software 15 = | This is the computer program specially |
| | designed for this overall system 1. It is to |
| | be installed in all NS, VBCS, TNS, WC |
| | systems to allow these systems to perform |
| | accordingly. |

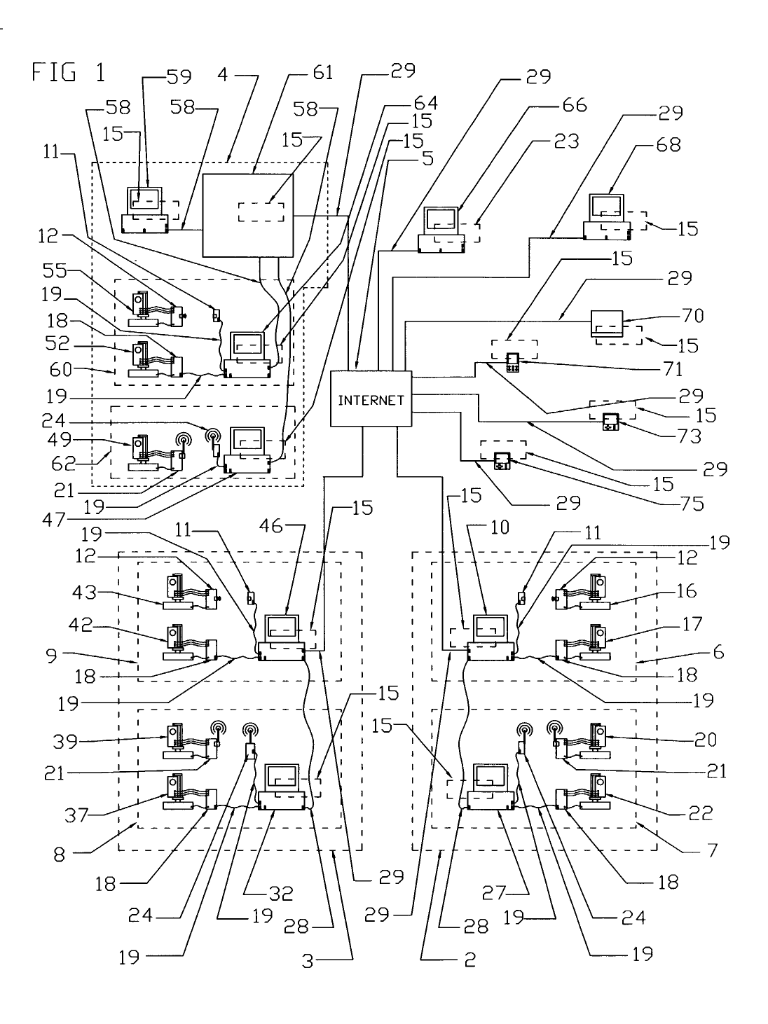

FIG. 1 is the overall system 1 of the complete Universal Dynamic Video On Demand Surveillance Network System. As shown in the drawing the system is consisted of LAVSN 2, LAVSN 3 and LAVSN 4 all are connected to Internet 5. In practice the number of LAVSN systems 2, 3 and 4 are infinite. Any LAVSN system can link to each other via Internet 5. The overall system 1 also comprises of the server system 66, Web computer station 68, Portable Web computer station 70, Handheld PC Web computer station 71, Equipment Mounted Web computer station 73 and Mobile Web computer station 75 and all are connected to the Internet 5 via connecting system 29.

LAVSN 2, which can be an Intranet system or LAN (local area network) system, includes NS 6 and NS 7. The number of NS 6 and NS 7 systems within the LAVSN 2 is users' choice. In practice at least one NS (node station) system is present in the LAVSN 2.

NS 6 comprises of a VBCS 10, which is connected to VS 16 via the IR signals bundler, receiver & transmitter 12, the IR signals converter, receiver & transmitter 11 and a connecting cable 19. The VBCS 10 is also connected to VS 17 via the signal bundler & converter 18 by a connecting cable 19. In practice, it is users' choice to determine the quantity of video station (VS) systems, RF signals bundler, receiver & transmitter 21, RF signals converter, receiver & transmitter 24, IR signals bundler, receiver & transmitter 12, IR signals converter, receiver & transmitter 11 and signal bundler & converter 18 to be connected to the VBCS 10. The operation software 15 is installed in VBCS 10 to provide the VBCS 10 the necessary control and computing capability as node system computer.

NS 7 comprises of a VBCS 27, which is connected to VS 20 via the RF signals bundler, receiver & transmitter 21, the RF signals converter, receiver & transmitter 24 and a connecting cable 19. The VBCS 27 is also connected to VS 22 via the signal bundler & converter 18 by a connecting cable 19. In practice, it is users' choice to determine the quantity and types of video station VS systems, RF signals bundler, receiver & transmitter 21, RF signals converter, receiver & transmitter 24, IR signals bundler, receiver & transmitter 12, IR signals converter, receiver & transmitter 11 and signal bundler & converter 18 to be connected to the VBCS 27. The operation software 15 is installed in VBCS 27 to provide the VBCS 27 the necessary control and computing capability as node system computer.

VBCS 10 is connected to VBC2 27 by connecting system 28 and also to the Internet 5 via the connecting system 29.

LAVSN 3, which can be an Intranet system or LAN (local area network) system, includes NS 8 and NS 9. The number of NS 8 and NS 9 systems within the LAVSN 3 is users' choice. In practice at least one NS (node station) system is present in the LAVSN 3.

NS 8 comprises of a VBCS 32, which is connected to VS 39 via the RF signals bundler, receiver & transmitter 21, the RF signals converter, receiver & transmitter 24 and a connecting cable 19. The VBCS 32 is also connected to VS 37 via the signal bundler & converter 18 by a connecting cable 19. In practice, it is users' choice to determine the quantity and types of video station (VS) systems, RF signals bundler, receiver & transmitter 21, RF signals converter, receiver & transmitter 24, IR signals bundler, receiver & transmitter 12, IR signals converter, receiver & transmitter 11 and signal bundler & converter 18 to be connected to the VBCS 32. The operation software 15 is installed in VBCS 32 to provide the VBCS 32 the necessary control and computing capability as node system computer.

NS 9 comprises of VBCS 46, which is connected to VS 43 via the IR signals bundler, receiver & transmitter 12, the IR signals converter, receiver & transmitter 11 and a connecting cable 19. The VBCS 46 is also connected to VS 42 via the signal bundler & converter 18 by a connecting cable 19. In practice, it is users' choice to determine the quantity of video station (VS) systems, RF signals bundler, receiver & transmitter 21, RF signals converter, receiver & transmitter 24, IR signals bundler, receiver & transmitter 12, IR signals converter, receiver & transmitter 11 and signal bundler & converter 18 to be connected to the VBCS 46. The operation software 15 is installed in VBCS 46 to provide the VBCS 46 the necessary control and computing capability as node system computer.

VBCS 46 is connected to VBCS 32 by connecting system 28 and is also connected to the Internet 5 via the connecting system 29.

LAVSN 4, which can be an Intranet system or LAN (local area network) system, includes a main frame computer system 61 with terminal node station TNS 60, TNS 62 and computer terminal 59 connected together. The number of TNS 60, TNS 62 and computer terminal 59 systems within the LAVSN 4 is users' choice. In practice at least one TNS Terminal node station is present in the LAVSN 4.

TNS 60 comprises of a VBCS 64, which is connected to VS 55 via the IR signals bundler, receiver & transmitter 12, the IR signals converter, receiver & transmitter 11 and a connecting cable 19. The VBCS 64 is also connected to VS 52 via the signal bundler & converter 18 by a connecting cable 19. In practice, it is users' choice to determine the quantity of video station VS systems, RF signals bundler, receiver & transmitter 21, RF signals converter, receiver & transmitter 24, IR signals bundler, receiver & transmitter 12, IR signals converter, receiver & transmitter 11 and signal bundler & converter 18 to be connected to the VBCS system 64.

TNS 62 comprises of a VBCS 47, which is connected to VS 49 via the RF signals bundler, receiver & transmitter 21, the RF signals converter, receiver & transmitter 24 and a connecting cable 19. In practice, it is users' choice to determine the quantity and types of video station VS systems, RF signals bundler, receiver & transmitter 21, RF signals converter, receiver & transmitter 24, IRs signal bundler, receiver & transmitter 12, IR signals converter, receiver & transmitter 11 and signal bundler & converter 18 to be connected to the VBCS system 47.

The TNS 60, TNS 62 and computer terminal 59 are all connected to the main frame computer 61 by connecting system 58, which can be cable connection system or wireless connection system; or any connection system which can facilitate the connection mean to the main frame computer 61. The main frame computer 61 is connected to the Internet 5 via the connecting system 29. It is the users' choice to determine the quantity of computer terminal 59, TNS 60 and TNS 62 to be connected to the main frame computer 61.

The operation software 15 is installed in the main frame computer 61 to provide the main frame computer 61 the necessary control and computing capability to allow its TNS1 60, TNS2 62 and computer terminal 59 to function as node system computer and data retrieval computer. The operation software 15 can also be installed to TNS1 60, TNS2 62 and computer terminal 59 if necessary.

The server system 66 is equipped with server software 23, which provides the overall system 1 with system security and data storage capability. The operation software 15 provides lower level security system to each stand alone station while the server software 23 provides high level security system for the overall system 1.

The Web computer (WC) 68 and portable Web computer (WC) 70 are equipped with operation software 15 and connected to the Internet 5 with connecting system 29.

The PC handheld Web computer (WC) 71, which also includes handheld PC computer, PDA, wearable computer, headset computer, mobile phone combined computer, is equipped with operation software 15 and connected to the Internet 5 with connecting system 29.

The equipment mounted Web computer (WC) 73, which also includes computer system installed or mounted to any equipment, is equipped with operation software 15 and connected to the Internet 5 with connecting system 29.

The mobile Web computer (WC) 75, which also includes computer system installed or resided in boats, automobiles, airplanes and spacecraft, is equipped with operation software 15 and connected to the Internet 5 with connecting system 29.

During operation the users at all Web computers (WC) 68, 70, 71, 73 and 75, VBCS stations 10, 27, 32, 46, 47 and 64, computer terminal 59 are eligible to control and retrieve data from the video station (VS) 16, 17, 20, 22, 37, 39, 42, 43, 49, 52 and 55. A pre-determined seniority system defines the access authorization of each user such that there will be no conflict if more than one users attempt to control a particular VS at the same time. The overall system 1 also allows the users to retrieve data from more than one video system (VS) and display them on the users' monitor screen simultaneously as multimedia display. The overall system 1 also allows the data of any video system (VS) to be sent to more than one users simultaneously; in results that more than one users can watch and hear the video and audio data taken by any particular video system simultaneously.

Further detail illustrations and explanations are shown in FIG. 2 to FIG. 11.

FIG. 2 is the illustration of a conventional computer station setup. The conventional computer station represents VBCS stations 10, 27, 32, 46, 47 and 64, computer terminal 59, Web computer station 68 and portable Web computer station 70. However, equipment mounted Web computer station 73 and mobile Web computer station 75 can also be a conventional computer station. VBCS 10 is illustrated in the FIG. 2.

The VBCS 10 is equipped with software 15 and is supported by the monitor 83, speakers 142, keyboard 148, mouse 146 and joystick 147. The monitor shows multimedia display with window MW 143, MW 144 and MW 145. The software 15 allows the VBCS 10 to perform multimedia function of retrieving data from more than one video station (VS) systems and displays them on the monitor screen simultaneously. Software 15 also allows the VBCS 10 to receive input data via the keyboard 148, mouse 146 and joystick 147 as the input device to perform remote-control functions of video station (VS) systems which VBCS 10 is communicating with. Furthermore, touch screen, capacitance probe, inductance probe, writing pad, wireless mouse, wireless keyboard, wireless joy stick and any other data inputting device which can facilitate as input device can also be used as data input device to the VBCS 10. The speakers 142 provide high quality audio sound simulating the ambient audio sound data captured at the video station (VS) systems. It is users' choice to determine the number of multimedia display windows (MW 13, 14 and 15) to be shown simultaneously. The users also can choose to broadcast the audio data from different VS systems at the speaker 142 together or just one at a time.

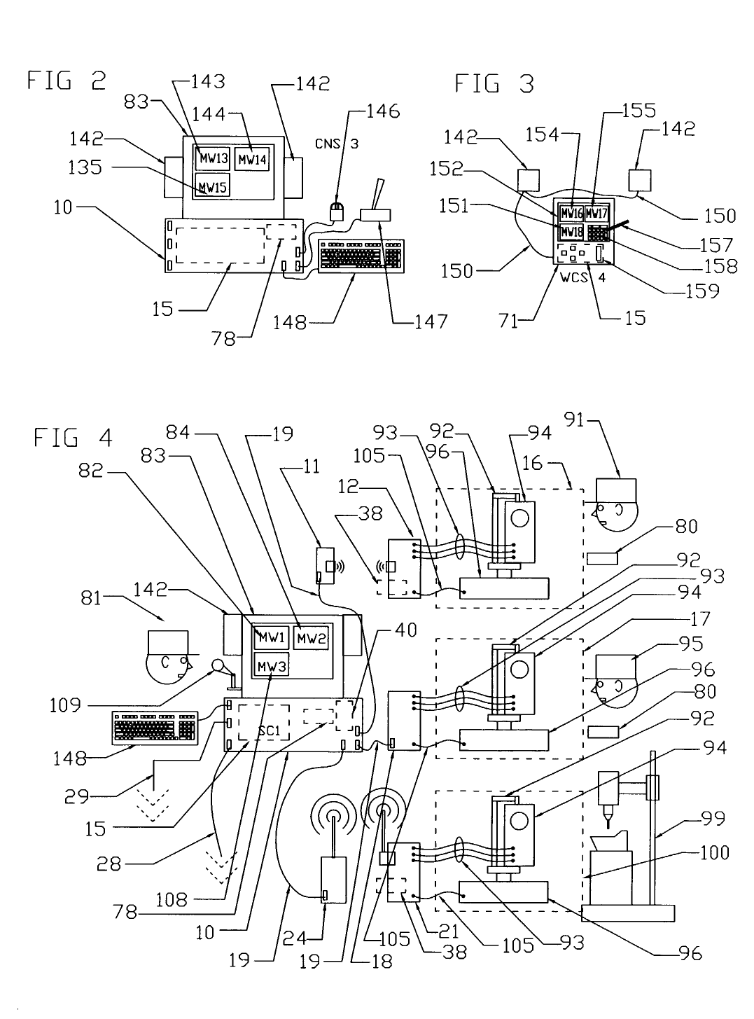

FIG. 3 is the illustration of a small handheld Web computer 71, which also includes the PC handheld type, PDA and combined system of mobile phone and computer units. However, equipment mounted Web computer station 73 and mobile Web computer station 75 can also be a handheld computer station.

The handheld Web computer 71 is equipped with software 15 and is supported by the LCD monitor display with touch screen 152, key pad 159 and speakers 142, which is connected to the handheld Web computer 71 by connecting cable 150. As shown in FIG. 3, the monitor shows multimedia display with MW 151, MW 154 and MW 155. The software 15 allows the handheld Web computer 71 to perform multimedia function of retrieving data from more than one video station (VS) systems and displays them on the monitor screen simultaneously. A virtual keypad 158 is also shown in the LCD monitor display with touch screen 152. The stylus pen 157 is used by user for activating the virtual keypad 158 as input device for the handheld Web computer 71.

Software 15 also allows the handheld Web computer 71 to receive input data via the keypad 159 and virtual keypad 158 as the input device to perform remote-control functions of video station (VS) systems which the handheld Web computer 71 is communicating with. Furthermore, capacitance probe, inductance probe, writing pad, wireless mouse, wireless keyboard, wireless joy stick and any other data inputting device which can facilitate as input device can also be used as data input device to the handheld Web computer 71. The speakers 142 provide high quality audio sound simulating the ambient audio sound data captured at the video station (VS) systems. It is users' choice to determine the number of multimedia display windows to be shown simultaneously. The users also can choose to broadcast the audio data from different VS systems at the speaker 142 together or just one at a time.

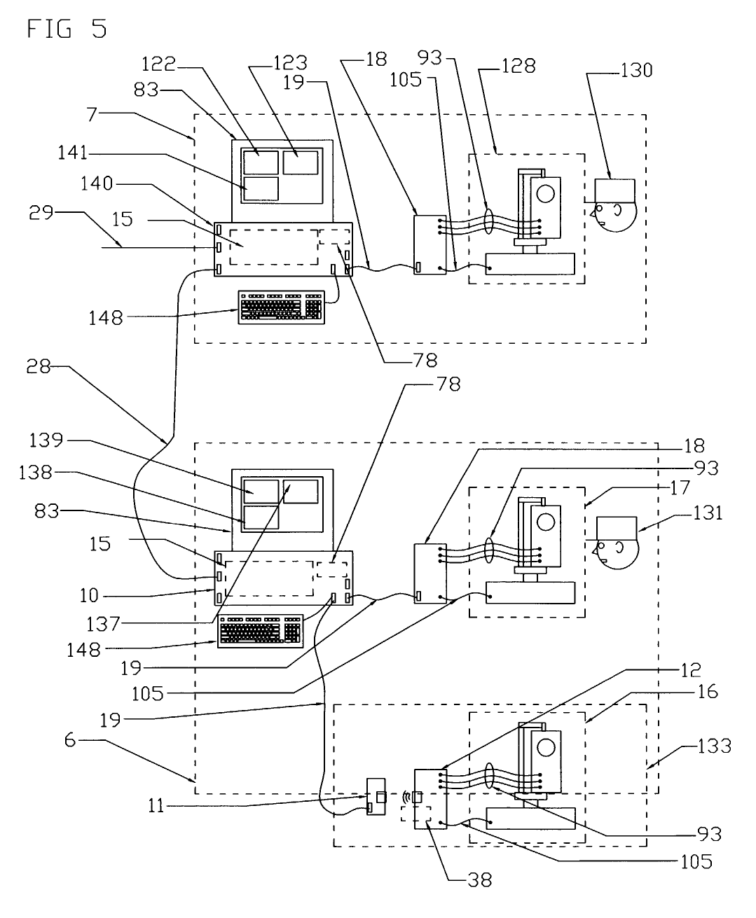

FIG. 4 illustrates node station (NS) system 6, which also represents the basic video on demand surveillance system. VBCS 10 is a conventional computer station with software 15 and is supported by a keyboard 148 and a monitor 83. An external intercom system is setup with the microphone 109 at the NS 6 and intercom speaker 80 at the video station (VS) area. Three video stations 16, 17 and 100 are connected to NS 6.

Video Station (VS) 16 comprises of a video camera 94 installed in a remote-control camera activator system 92 mounted on a remote-control equipment mounting device 96. Remote-control equipment mounting device 96 can perform vertical tilt motion and horizontal rotational motion as described in prior art disclosed in patent application Ser. No. 10/201,092 (Remote-control utility equipment mounting apparatus). The remote-control activator system 92 is described in prior art disclosed in patent application Ser. No. 10/142,069 (Remote-control device for video camera). This remote-control activator system 92 can control all the mechanical switches on the video camera body and the handheld controller provided with generic video camera. The video and audio signals captured by the video camera 94 are transmitted to IR signals bundler & transmitter 12 by cable 93. The remote-control activator system 92 and the remote-control equipment mounting device 96 are connected to the IR signals bundler, receiver & transmitter 12 by cable 105. The IR signals bundler, receiver & transmitter 12 bundles up the video and audio signals, the control signal feedback from remote-control function of activator system 92 and the control signal feedback from remote-control function of equipment mounting device 96 together and encodes them into a combined signal function 38. The IR signals bundler, receiver & transmitter 12 then emits the combined signal function 38 out with the built-in IR transmitter. The IR signals converter, receiver & transmitter 11, which has built-in IR signals receiver, receives the combined signal function 38 and decodes the combined signal function 38 into decoded signal function 40, which includes the video and audio signals, the control signal feedback from remote-control function of activator system 92 and the control signal feedback from remote-control function of equipment mount 96 respectively, and then sends all the signals to VBCS 10 via the signal cable 19. The decoded signal function 40 can be digital signals, analog signals or combination of digital and analog signals. The video signals of the decoded signal function 40 can be of NTSC, PAL, MPEG, VCD, DVD or any other video signal formats; and they can be compressed or non-compressed data signals. The audio signals of the decoded signal function 40 can be of WAV, MP3 format or any other audio signal formats; and they can be compressed or non-compressed data signals.

In operation, user 81 can use the keyboard 148 to control the pan and tilt functions of the video camera 94; and all the functions of the video camera 94. As VBCS 10 picks up an input signal from the keyboard 148, the software 15 will generate a corresponding signal function 78. This signal function 78 will then be sent to IR signals converter, receiver & transmitter 11 through cable 19. This signal will be converted into signal function 38 and emitted out. The IR signals bundler, receiver & transmitter 12 detects the signal function 38 and generates corresponding electrical driving functions to the designated electrical components of the remote-control camera activator system 92 and the remote-control equipment mounting device 96 respectively. In results, the video camera 94 will be tilted, rotated, instructed to perform zooming functions or other specific functions according to the input instruction from the user 84. The video and audio signals are also sent back to the VBCS 10 and the software 15 will show the video picture in the multimedia window 143 of the monitor 83. The audio will also be sent to the speakers 142 and user 84 can listen to all the sound or conversation which the video camera 94 has captured.

As shown in FIG. 4, User 91 is in front of VS 16 and is reporting to user 81. The speech of user 91 is captured by the built in microphone system of the video camera 94 and sent to the speaker 142 of VBCS 10 while user 91 can listen to user 81 via the microphone 109 and intercom speaker system 80. As a result, user 81 and user 91 can communicate verbally without interference. Furthermore, user 81 can see user 91 in the multimedia window 82 of the monitor 83.

Video Station (VS) 17 and 100 comprise of the same component elements of 94, 92, 96, 93 and 105 as VS 16. VS 17 is connected to signals bundler & converter 18, which is connected to VBCS 10 by cable 19. As shown in FIG. 4, User 95 is in front of VS 17 and is reporting to user 81. The speech of user 95 is captured by the built in microphone system of the video camera 94 and sent to the speaker 142 of VBCS 10 while user 95 can listen to user 81 via the microphone 109 and intercom speaker system 80. As a result, user 81 and user 95 can communicate verbally without interference. Furthermore, user 81 can see user 91 in the multimedia window 84 of the monitor 83.

VS 100 is connected to RF signals bundler, receiver & transmitter 21 through cable 93 and cable 105. The video and audio signals captured by the video camera 94 are transmitted to RF signals bundler & transmitter 21 by cable 93. The remote-control activator system 92 and the remote-control equipment mounting device 96 are connected to the RF signal bundler, receiver & transmitter 21 by cable 105. The RF signals bundler, receiver & transmitter 21 bundles up the video and audio signals, the control signal feedback from remote-control function of activator system 92 and the control signal feedback from remote-control function of equipment mounting device 96 together and encodes them into combined signals function 38. The RF signals bundler, receiver & transmitter 21 then emits the combined signals function 38 out with the built-in RF transmitter. The RF signals converter, receiver & transmitter 24, which has built-in RF signals receiver, receives the combined signal function 38 and decodes the combined signal function 38 into decoded signal function 40, which includes the video and audio signals, the control signal feedback from remote-control function of activator system 92 and the control signal feedback from remote-control function of equipment mounting device 96 respectively, and then sends all the signals to VBCS 10 via the signal cable 19. The decoded signal function 40 can be digital signals, analog signals or combination of digital and analog signals. The video signals of the decoded signal function 40 can be of NTSC, PAL, MPEG, VCD, DVD or any other video signal formats; and they can be compressed or non-compressed data signals. The audio signals of the decoded signal function 40 can be of WAV, MP3 format or any other audio signal formats; and they can be compressed or non-compressed data signals.

As shown in FIG. 4, Machine 99 is in front of VS 100. The ambient noise is captured by the built in microphone system of the video camera 94 and sent to the speaker 142 of VBCS 10. As a result, user 81 can listen to the machining sound and visualize if the process is normal or not in the multimedia window 108 of the monitor 83. User 81 can also conference in user 91 and user 95 together and all three user 81, 91 and 95 can listen and discuss about the processing noise of machine 99 together. This is a great tool for manufacturing processes control especially user 81 can perform rotate and tilt, zoom in or out functions of the video camera 94 with the keyboard 148 in front of him. VBCS 10 can also be connected to other node systems (NS) via the connecting system 28 or to the Internet via the connecting system 29.

FIG. 5 is showing a local area video surveillance network system (LAVSN) 2 with NS 6 and NS 7 linked together by connecting system 28. FIG. 5 also represents a basic dynamic video on demand teleconferencing system. NS 6 comprises of the same setup and components as in FIG. 4 except without the VS 100 system. User 131 is controlling the VBCS 10 and is in front of VS 17. Remote video site 133 comprises of VS 16, IR signals bundler, receiver & transmitter 12 and IR signals converter, receiver & transmitter 11 is connecting to VBCS 10 via the cable 19.

NS 7 comprises of the same setup and components as NS6 (in FIG. 5) without the remote video site 133. User 130 is controlling the VBCS 140 and is in front of VS 128.

In practice, initial conditions require both VBCS 10 and VBCS 140 have software 15 installed and activated; user 131 uses VBCS 10 to send request to VBCS 140 to establish the proper handshake between the two VBCS 10 and 140. After the software 15 handshake is completed at both VBCS 10 and 140, both user 131 and user 130 can control both VS 128 and VS 17. As a result, both users can demand and retrieve the particular video images, focusing, magnification (zoom quality) etc. from VS 128 and VS17. They can also hear each other via the built in microphones of the video cameras 94 from the speakers 142 of the VBCS 10 and 140 respectively. Thus, this system represents a dynamic video on demand teleconferencing system. Two user video base computer stations (VBCS 10 and VBCS 140) are shown in the drawing; in practice, it is users' choice to determine the number of user video base computer stations to be in the teleconferencing system. The software 15 also provides the users a choice to set an user authority list with pre-defined seniority table for the users so that there will be no conflicts when two or more users try to control the same VS at the same time.

As the remote video site 133 is connected to VBCS 10, both users 131 and 130 can access the control of VS 16 of remote video site 133. VS 16 is a surveillance camera system installed at a specific location. As a result, both users 131 and 130 can watch the video and audio data captured by VS 16 instantly and remotely control all the functions of the video camera 94 of the VS 16 and the image capturing direction as well. Thus, this present invention represents the dynamic video on demand surveillance system with multiple users. In practice, it is users' choice to determine the quantity of remote video site 133 to be in the system and the authorization of access right to users.

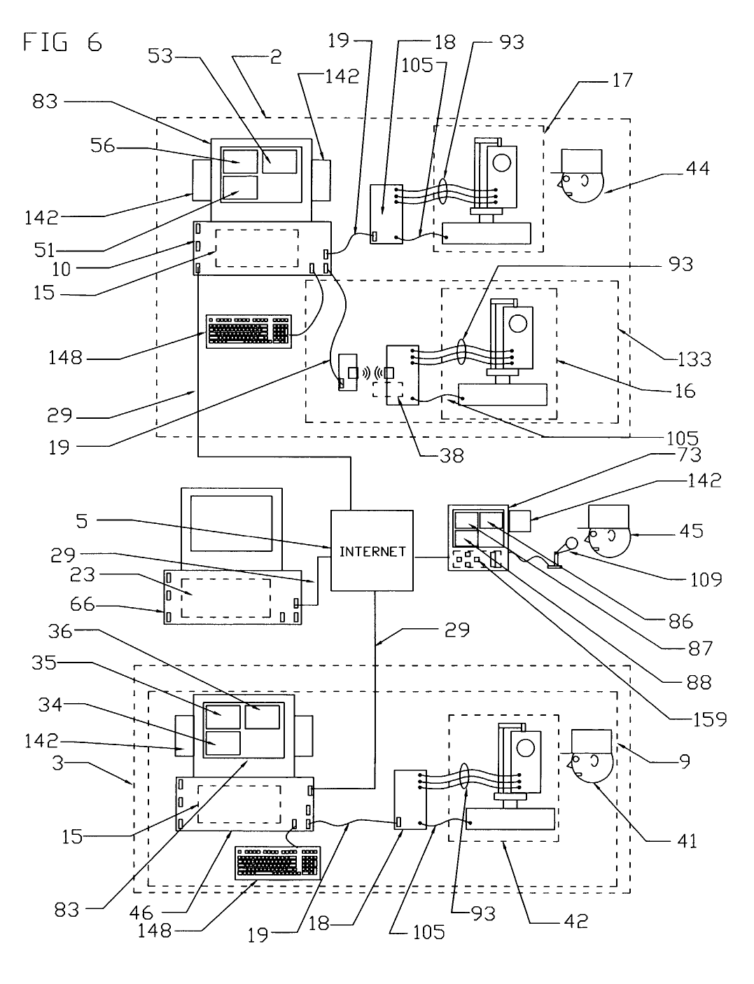

FIG. 6 shows the universal dynamic video on demand surveillance system including the universal dynamic video on demand teleconferencing system. The NS 6 of LAVSN 2 comprises of the same setup and components as NS 6 shown in FIG. 5 and is connected to Internet 5 via the connecting system 29. The NS 9 of LAVSN 3 comprises of the same setup and components as NS 7 shown in FIG. 5 and is connected to Internet 5 via the connecting system 29. Both Web computer 73 and server 66 are connected to Internet 5 via connecting systems 29.

In operation, initial conditions require all involved systems in the community network, which is defined as all the equipments in the surveillance system shown in FIG. 6, have the software 15 installed and activated. VBCS 10 connects to the VBCS 46 address through the Internet 5 and initiates the software handshaking processes between the software 15 of both systems. This handshake also includes authorization verification by both VBCS systems. Upon the completion of handshaking processes, user 44 at VBCS 10 and user 41 at VBCS 46 will communicate the way same as user 130 and user 131 of FIG. 5. As user 45 initiates the connection to VBCS 10 with Web computer (WC) 73, the software 15 of both systems will go through the same software handshaking processes with WC 73. Upon the completion of handshaking processes user 45 will join in and communicate with user 44 and user 41 through their VBCS and Web computer systems. Furthermore, they also can remotely control all the VS in the overall system (community network). Thus, this system represents the universal dynamic video on demand teleconferencing system.

In practice, an user can communicate to all the VBCS systems as he gets connected with access approval to any one of the VBCS systems which is already in the communication community, which represents the universal dynamic video on demand teleconferencing system. It is users' choice to define the number of users in the overall communication community.

As the remote video site 133 is connected to VBCS 10, all users in the communication community can access the control of VS 16 of remote video site 133. VS 16 is a surveillance camera system installed at a specific location. As a result, all users can watch and listen to the video and audio data captured by VS 16 instantly and remotely control all the functions of the video camera 94 of the VS 16 and the image capturing direction as well. Thus, this present system represents the universal dynamic video on demand surveillance system with multiple users. In practice, it is users' choice to determine the quantity of remote video site 133 to be in the system and the authorization of access right to users.

The server 66 equipped with server software 23 is connected to the Internet 5 via connecting system 29. It can serve as the data center such that it can store data when requested by users from any VBCS in the communication community. It can also function as the centralized authorization center for all users to have connection authorization verified before gaining access to the communication community. This provides security to all users from data contamination, hacking and theft. Thus this system represents the universal dynamic video on demand surveillance system with security protection.

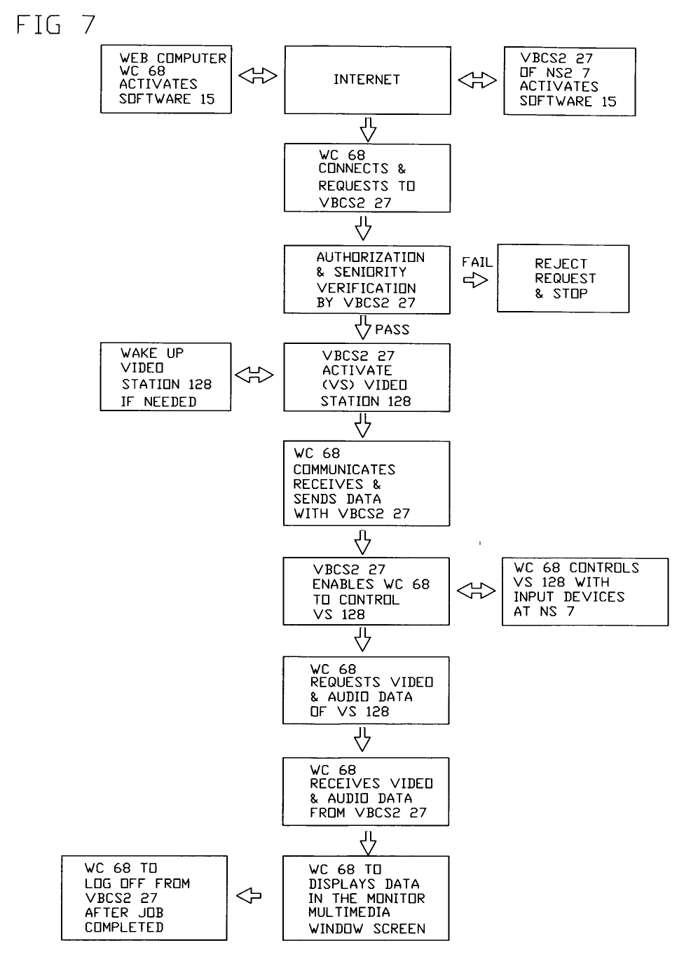

FIG. 7 is the retrieval process flow chart of direct communication by a Web computer (WC 68) system on requesting and retrieving data from VBCS 27 of node station 7. Video station 128 is the video station of node station 7. The initial condition requires VBCS 27 has the software 15 up and running and is linked to the Internet 5; and the identity and password of the Web computer 68 is already in VBCS 27's data record. The Web computer 68 is also required to have the software 15 up and running and is linked to the Internet 5. Through the Internet connection WC 68 connects to VBCS 27 and sends request for communication to VBCS 27. VBCS 27 will then check for verification of WC 68's identity and password. If failed, request from Web computer 68 will be rejected. Otherwise, VBCS 27 will activate video station 128 after verification and approval of WC 68's identity and will wake up VS 128 if it is in sleep mode. Through the Internet 5 connection, VBCS 27 communicates with WC 68 and enables WC 68 to submit controlling input requests for VS 128; and VBCS 27 will act accordingly to control the VS 128 as per WC 68's request. VBCS 27 will collect the result data, which also includes the video and audio signals from VS 128 and then sends the data back to WC 68 via the Internet 5 connection. Upon receipt of the data, WC 68 will display the video data on the monitor screen. This data display window can also be a multimedia window. WC 68 can also broadcast the audio data through the speakers 142.

Web computer 68 can stay on working with VBCS 27 as long as it needs and receives instant responding video and audio data from video station 128. Web computer 68 will log off from VBCS 27 after completion. Thus, this represents a basic dynamic video on demand surveillance system.

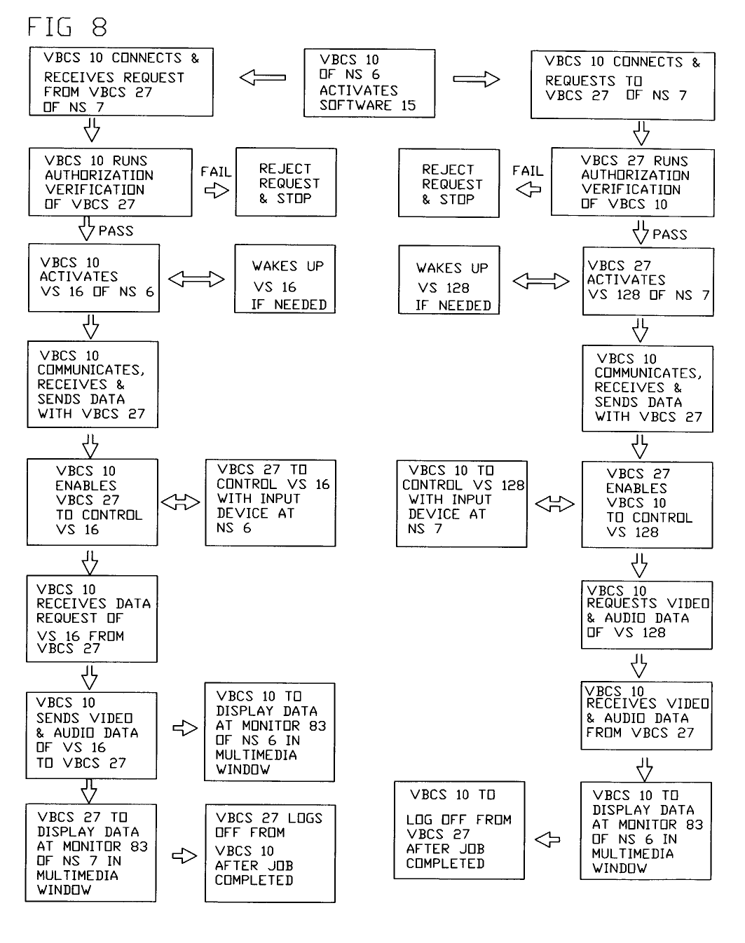

FIG. 8 is the dynamic video on demand communication flow chart between two node station (NS) systems within a LAVSN system. FIG. 8 illustrates the process of VBCS 10 of NS 6 initiates the connection to VBCS 27 of NS 7 and then establishes the communication between the two systems. Initial conditions require that the two systems VBCS 10 and VBCS 27 are linked together with connection system 28 and both systems have software 15 running. The overall process is composed of (a) the demand and retrieval process of request made by VBCS 10 and (b) the verification of authorization and supporting process of VBCS 10 in response to request from VBCS 27.

The demand and retrieval process of VBCS 10 is similar to the process for Web computer 68 as stated in FIG. 7 description except without connecting to the Internet 5. Process begins with VBCS 10 sends request for communication to VBCS 27. VBCS 27 will then check for verification of VBCS 10's identity and password. If failed, request from VBCS 10 will be rejected. Otherwise, VBCS 27 will activate video station 128 after verification and approval of VBCS 10's identity. If video station 128 is in sleep mode when not being used; VBCS 27 will wake up and activate video station 128. VBCS 27 communicates with VBCS 10 and enables VBCS 10 to submit controlling input requests for video station 128 and VBCS 27 will act accordingly to control the video station 128 as per VBCS 10's request. VBCS 27 will collect the result data, which also includes the video and audio signals from video station 128 and then send the data back to VBCS 10. Upon receipt of the data, VBCS 10 with the software 15 will display the video data on the monitor screen. This data display window can also be a multimedia window. VBCS 10 can also display the audio data through the speakers 142. It is VBCS 27's user choice to display the data from video station 128 on the multimedia window screen of VBCS 27.

VBCS 10 can stay on working with VBCS 27 as long as it needs and receives instant responding video and audio data from video station 128. VBCS 10 will log off from VBCS 27 after completion.

The verification of authorization and supporting process of VBCS 10 in response to request from VBCS 27 begins with VBCS 10 receives authorization request from VBCS 27. VBCS 10 searches through its databases to verify if VBCS 27 is a registered user and if the password is correct. Process will stop if results are negative. Otherwise VBCS 10 will activate video station 16 after verification and approval of VBCS 27's identity. If video station 16 is in sleep mode when not being used; VBCS 10 will wake up and activate video station 16. VBCS 10 communicates with VBCS 27 and enables VBCS 27 to submit controlling input requests for video station 16 and VBCS 10 will act accordingly to control the video station 16 as per VBCS 27's request. VBCS 10 will collect the result data, which also includes the video and audio signals from video station 16 and then send the data back to VBCS 27. Upon receipt of the data, VBCS 27 with the software 15 will display the video data on the monitor screen. This data display window can also be a multimedia window. VBCS 27 can also display the audio data through the speakers 142. It is VBCS 10's user choice to display the data from video station 16 on the multimedia window screen of VBCS 10.

VBCS 10 will stay on supporting VBCS 27 as long as it receives request from VBCS 27 and send instant responding video and audio data from video station 16 to VBCS 27 until VBCS 27 logs off from VBCS 10 after completion.

This represents dual channels dynamic video on demand communication with multimedia window display at the VBCS 10 and 27. In practice, it is users' choice to determine how many users VBCS systems can join together at the same time and how many multimedia windows to be display at the same time. All the processes of (a) the demand and retrieval process of requesting to VBCS 10 and (b) the verification of authorization and supporting process in response to request from VBCS 10 will be automatically initiated as another VBCS or Web computer connects to VBCS 10. Upon approval, all the processes of (a) the demand and retrieval process of requesting to other VBCS systems in the community and (b) the verification of authorization and supporting process in response to request from VBCS in the community will be automatically initiated. Since software 15 is installed in all computer systems therefore they are all capable of multimedia functions, the process of new system introduction can run in parallel with other current supporting functions. The new arrival VBCS or Web computer will join, request and retrieve data from the community system upon approval of authorization from all present VBCS in the community system.

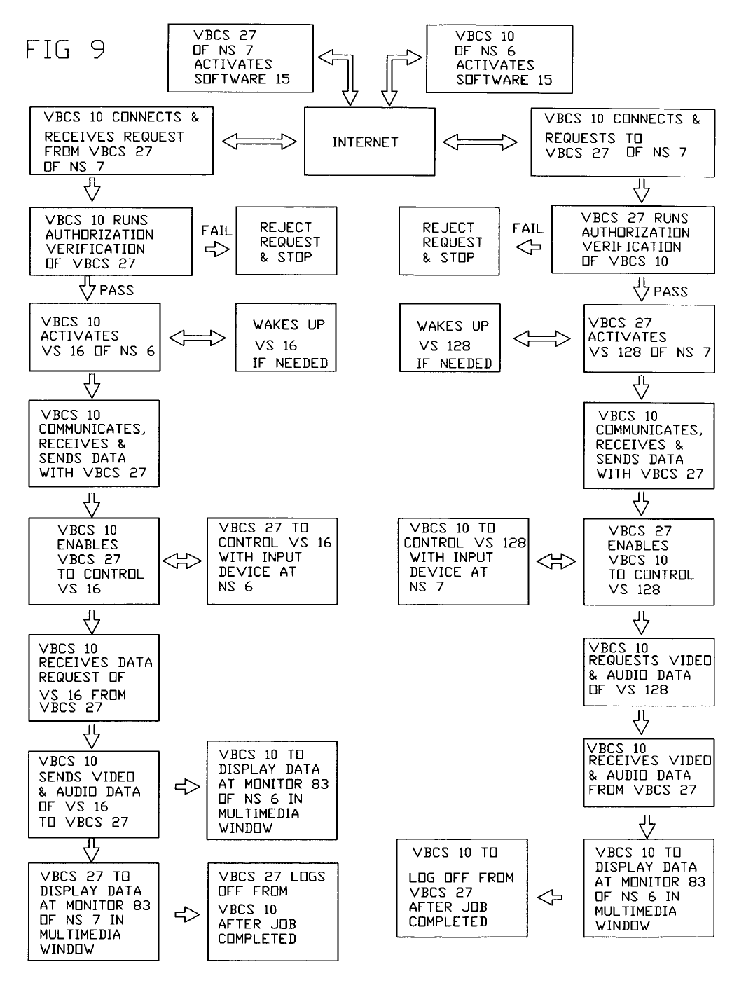

FIG. 9 is the dynamic video on demand communication flow chart between two node station (NS) systems of two LAVSN systems. FIG. 9 illustrates the process of VBCS 10 of NS 6 initiates the connection to VBCS 27 of NS 7 via Internet 5 and then establishes the communication between the two systems. Initial conditions require that the two systems VBCS 10 and VBCS 27 are both connected to Internet 5 with connection system 29 and both systems have software 15 running. The overall process is composed of (a) the demand and retrieval process of request from VBCS 10 to VBCS 27 and (b) the verification of authorization and supporting process of VBCS 10 in response to request from VBCS 27.

The demand and retrieval process of VBCS 10 begins with VBCS 10 sends request for communication to VBCS 27 via Internet 5. VBCS 27 will then check for verification of VBCS 10's identity and password. If failed, request from VBCS 10 will be rejected. Otherwise, VBCS 27 will activate video station 128 after verification and approval of VBCS 10's identity. If video station 128 is in sleep mode when not being used; VBCS 27 will wake up and activate video station 128. VBCS 27 communicates with VBCS 10 through the Internet 5 thereafter. VBCS 27 enables VBCS 10 to submit controlling input requests for video station 128 and will act accordingly to control the video station 128 as per VBCS 10's request. VBCS 27 will collect the result data, which also includes the video and audio signals from video station 128 and then send the data back to VBCS 10. Upon receipt of the data, VBCS 10 with the software 15 will display the video data on the monitor screen. This data display window can also be a multimedia window. VBCS 10 can also display the audio data through the speakers 142. It is VBCS 27's user choice to display the data from video station 128 on the multimedia window screen of VBCS 27.

VBCS 10 can stay on working with VBCS 27 through the Internet 5 connection as long as it needs and receives instant responding video and audio data from video station 128. VBCS 10 will log off from VBCS 27 after completion.

The verification of authorization and supporting process of VBCS 10 in response to request from VBCS 27 begins with VBCS 10 receives authorization request from VBCS 27 through the Internet 5. VBCS 10 searches through its databases to verify if VBCS 27 is a registered user and if the password is correct. Process will stop if results are negative. Otherwise VBCS 10 will activate video station 16 after verification and approval of VBCS 27's identity. If video station 16 is in sleep mode when not being used; VBCS 10 will wake up and activate video station 16. VBCS 10 communicates with VBCS 27 through the Internet 5 thereafter. It enables VBCS 27 to submit controlling input requests for video station 16 and will act accordingly to control the video station 16 as per VBCS 27's request. VBCS 10 will collect the result data, which also includes the video and audio signals from video station 16 and then send the data back to VBCS 27. Upon receipt of the data, VBCS 27 with the software 15 will display the video data on the monitor screen. This data display window can also be a multimedia window. VBCS 27 can also display the audio data through the speakers 142. It is VBCS 10's user choice to display the data from video station 16 on the multimedia window screen of VBCS 10.

VBCS 10 will stay on supporting VBCS 27 as long as it receives request from VBCS 27 and will send instantly responding video and audio data from video station 16 to VBCS 27 until VBCS 27 logs off from VBCS 10 after completion.

This represents dual channels dynamic video on demand communication with multimedia window display via Internet 5 connection at the VBCS 10 and 27. In practice, it is users' choice to determine how many user VBCS systems can join together at the same time and how many multimedia windows to be display at the same time. All the processes of (a) the demand and retrieval process of requesting to VBCS 10 and (b) the verification of authorization and supporting process in response to request from VBCS 10 will be automatically initiated as another VBCS or Web computer connects to VBCS 10 via Internet 5. Upon approval, all the processes of (a) the demand and retrieval process of requesting to other VBCS in the community by the new comer and (b) the verification of authorization and supporting process in response to request from all VBCS systems in the community will be automatically initiated. Since software 15 is installed in all computer systems therefore they are all capable of multimedia functions, the process of new system introduction can run in parallel with other current supporting functions. The new arrival VBCS or Web computer will join, request and retrieve data from the community system upon approval of authorization from all present VBCS systems in the community system.

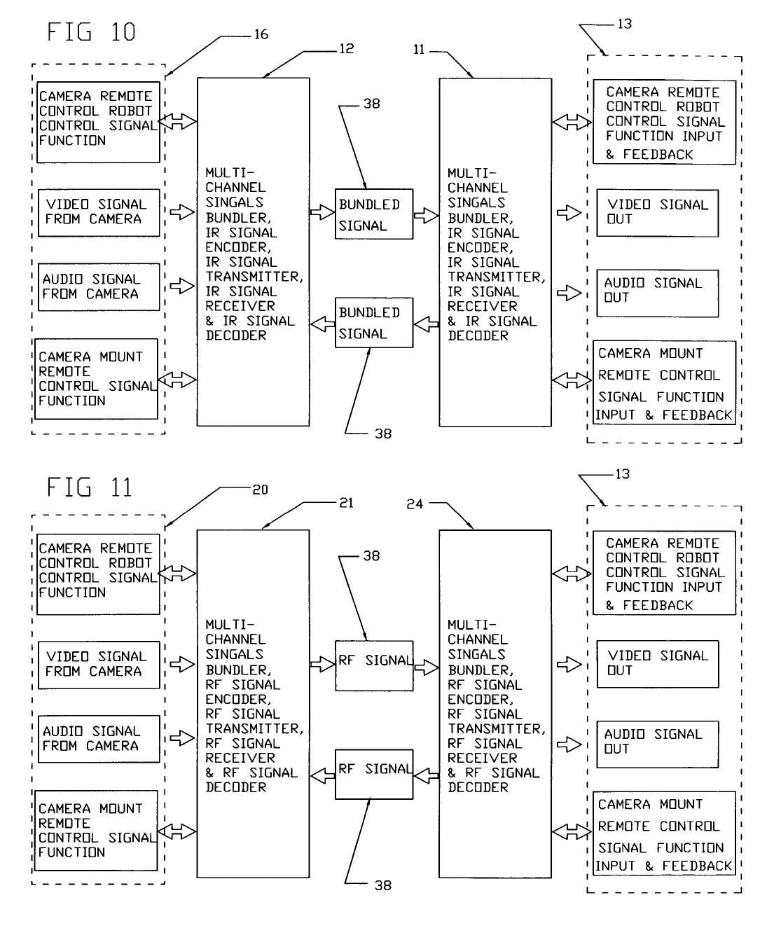

FIG. 10 is the signal communication flow chart from the video system (VS) 16, which includes the video camera, remote control camera mount, remote control device for video camera; the IR (infrared) signals bundler, receiver, & transmitter 12 and IR signals converter, receiver & transmitter 11 to the input/output data connector 13, which is to be connected to VBCS 10 of the NS 6 computer system.

Video Station (VS) 16 comprises of a video camera 94 installed in a remote-control camera activator system 92 mounted on a remote-control equipment mounting device 96. Remote-control equipment mounting device 96 can perform vertical tilt motion and horizontal rotational motion as described in prior art disclosed in patent application Ser. No. 10/201,092 (Remote-control utility equipment mounting apparatus). The remote-control activator system 92 is described in prior art disclosed in patent application Ser. No. 10/142,069 (Remote-control device for video camera).

Process begins at the I/O data connector 13. As soon as I/O data connector 13 receives input signals for the control of remote-control activator system 92 and the equipment-mounting device 96 from the VBCS 10, it will pass all the input signals to the IR signals converter, receiver, & transmitter 11, where all signals will be encoded or encrypted into signals function 38 and emitted out through the built in IR electronic components. IR signals bundler, receiver, & transmitter 12 will detect and receive the signals function 38 and decode it into driver functions to drive the camera remote-control activator system 92 and the remote control equipment mounting device 96 respectively. The feedback signals from camera remote-control activator system 92 and the remote-control equipment-mounting device 96 are sent to the IR signals bundler, receiver, & transmitter 12. The video and audio signals captured by the video camera 94 are also sent to the IR signals bundler, receiver, & transmitter 12, where all the signals will be encoded or encrypted together as signal function 38 and then emitted out through the built in IR electronic components. The IR signals converter, receiver, & transmitter 11 will detect and receive the signal function 38; and decode it into camera remote-control activator system 92 feedback output signals, equipment-mounting device 96 remote control feedback signals, video data signals and audio data signals functions, and all these signals will be passed to the I/O data connector 13. Thus, the signals function 38 is the bundled signals, which also includes video and audio signals being transmitted and received between IR signals bundler, receiver, & transmitter 12 and IR signals converter, receiver, & transmitter 11 wirelessly.

FIG. 11 is the signal communication flow chart from the video system (VS) 20, which includes the video camera, remote control equipment mounting device 96, remote control activator system 92 for video camera; the RF signals bundler, receiver, & transmitter 21 and RF signals converter, receiver & transmitter 24 to the input/output data connector 13, which is to be connected to VBCS 27 of the NS 7 computer system.

Video Station (VS) 20 comprises of a video camera 94 installed in a remote-control camera activator system 92 mounted on a remote-control equipment mounting device 96. Remote-control equipment-mounting device 96 can perform vertical tilt motion and horizontal rotational motion as described in prior art disclosed in patent application Ser. No. 10/201,092 (Remote-control utility equipment mounting apparatus). The remote-control activator system 92 is described in prior art disclosed in patent application Ser. No. 10/142,069 (Remote-control device for video camera).

Process begins at the I/O data connector 13. As soon as I/O data connector 13 receives input signals for the control of the remote-control activator system 92 and the equipment-mounting device 96, it will pass all the input signals to the RF signals converter, receiver, & transmitter 24, where all signals will be encoded or encrypted as signal function 38 and emitted out through the built in RF electronic components. RF signals bundler, receiver, & transmitter 21 will detect and receive the signal function 38 and decode it into driver functions to drive the camera remote-control activator system 92 and the remote control equipment mounting device 96 respectively. The feedback signals from camera remote-control activator system 92 and the remote-control equipment-mounting device 96 are sent to the RF signals bundler, receiver, & transmitter 21. The video and audio signals captured by the video camera 94 are also sent to the RF signals bundler, receiver, & transmitter 21, where all the signals will be encoded or encrypted together as signal function 38 and then emitted out through the built in RF electronic components. The RF signals converter, receiver, & transmitter 24 will detect and receive the signal function 38; and decode it into camera remote-control activator system 92 feedback output signals, equipment-mounting device 96 remote control feedback signals, video data signals and audio data signals functions and all these signals will be passed to the I/O data connector 13. Thus, the signals function 38 is the bundled signals, which also includes video and audio signals being transmitted and received between RF signals bundler, receiver, & transmitter 21 and RF signals converter, receiver, & transmitter 24 wirelessly.

It will be appreciated that the sizes and shapes and dispositions of various node systems, camera remote-control activator system, equipment mounting device, generic video camera, handheld PC systems, computer systems, server computer, pointing devices, IR transceivers, IR receivers, RF transceivers, RF receivers and signals bundlers can be varied, without departing from the spirit and scope of the invention. Similarly, the sizes and colors of the multimedia window display, and the like may be varied. While the method of connection to networks, Intranet, the Internet has been described with respect to current available technology, other future connecting means may instead (or in addition) be used. While the computers, servers, handheld computers has been described with current available equipment, other future advance computers, faster CPUs, microprocessors and other computing devices may instead ( or in addition) be used. While the surveillance system and the teleconferencing system have been described with respect to application with video cameras with capability of audio capturing, the described system may be applied to other video cameras including without limitation to use digital cameras.

Modifications and variations may be made to the disclosed embodiments without departing from the subject and spirit of the invention as defined by the following claims.

What is claimed is:

1. An Universal Dynamic Video On Demand Surveillance System comprising:
Video station subassemblies, which are individually consisted of:
A video camera
A remote control device for video camera
A remote control utility equipment mounting apparatus
A video and audio signal cable
A remote-controller cable
IR (Infrared) signals bundler, receiver & transmitter units
IR signals converter, receiver & transmitter units
RF (Radio frequency) signals bundler, receiver & transmitter units
RF signals converter, receiver & transmitter units
Wirelessly transmittable combined signals function
Signals bundler & converter units
Node station computers with operating system software, keyboard, mouse and monitor
Web access computers with operating system software
Connection cables
Connecting system between two computers
Connecting system from computer to Internet
Video on demand computer software
Server computer
Video on demand server software

2. The apparatus of claim 1, wherein said the said Universal Dynamic Video On Demand Surveillance System is also a telephone conferencing system with video on demand features.

3. The apparatus of claim 1, wherein said the said video camera also includes audio sound signals capturing capability can be a commercially available personal handheld video camera or an industrial surveillance camera.

4. The apparatus of claim 3, wherein said the said video camera also has zooming functions, auto focusing functions, steady shot feature and low intensity filming.

5. The apparatus of claim 1, wherein said the said video camera also includes camcorder, still camera, digital camera, video camera with still picture capability and mobile phone with picture taking capability.

6. The apparatus of claim 1, wherein said the said video camera is equipped with handheld remote control unit.

7. The apparatus of claim 1, wherein said the said video camera is equipped with adaptor for external microphone.

8. The apparatus of claim 1, wherein said the said remote control device for video camera is equipped with electronic components to control all the functions of the said video camera and mechanical assembly to support the said video camera physically.

9. The apparatus of claim 8, wherein said the said remote control device for video camera is equipped with electronic components to receive input control signals from external equipment and to send feedback control signals to the said external equipment.

10. The apparatus of claim 9, wherein said the said remote control device for video camera is equipped with electromechanical components to control all the switches on the body of the said video camera.

11. The apparatus of claim 9, wherein said the said remote control device for video camera is equipped with electromechanical components to control all the switches on the handheld remote controller of the video camera.

12. The apparatus of claim 11, wherein said the said remote control device for video camera is equipped with light channel to transfer the IR signals from the handheld remote controller of the video camera to IR signals receiving lens of the body of the said video camera.

13. The apparatus of claim 1, wherein said the said remote control utility equipment mounting apparatus is equipped with mechanical means to provide mounting support for the said remote control device for video camera with the said video camera installed in it, electronic components to drive the motorized mechanism to perform vertical tilt function and the motorized mechanism to perform horizontal rotational function.

14. The apparatus of claim 13, wherein said the said remote control utility equipment mounting apparatus is equipped with electronic components to receive input control signals from external equipment and to send feedback control signals to the said external equipment.

15. The apparatus of claim 1, wherein said the said video station subassembly is rain resistance and transparent cover is also provided for the said video camera.

16. The apparatus of claim 1, wherein said the method of using the said video station as a remote control surveillance video camera system.

17. The apparatus of claim 16, wherein said the said video station is produced by using the said video camera installed in the said remote control device for video camera and mounted on the said remote control utility equipment mounting apparatus.

18. The apparatus of claim 17, wherein said the said video camera also includes camcorder, still camera, digital camera, video camera with still picture capability and mobile phone with image picture taking capability.

19. The apparatus of claim 17, wherein said the said video station can be controlled by electrical signals input from external equipment.

20. The apparatus of claim 1, wherein said the said IR signals bundler, receiver & transmitter unit receives video signals and audio signals from the said video camera, control and feedback signals for the said remote control device for video camera and control and feedback signals for the said remote control utility equipment mounting apparatus.

21. The apparatus of claim 20, wherein said the said IR signals bundler, receiver & transmitter unit groups together and encodes together all the said signals into one combined signal function as the said wirelessly transmittable combined signals function.

22. The apparatus of claim 21, wherein said the said IR signals bundler, receiver & transmitter unit emits the said wirelessly transmittable combined signals function as a wireless IR signal function.

23. The apparatus of claim 21, wherein said the method of grouping together and encoding together video signals and audio signals from the said video camera, control and feedback signals for the said remote control device for video camera and control and feedback signals for the said remote control utility equipment mounting apparatus into one combined signals function and emits this said combined signals function out as an IR (infrared) transmittable signals function.

24. The apparatus of claim 1, wherein said the said IR signals converter, receiver & transmitter unit detects and receives the said wirelessly transmittable combined signals function and decodes it into standard computer communication functions of video signals, audio signals, feedback signals for the said remote control device for video camera and feedback signals for the said remote control utility equipment mounting apparatus functions.

25. The apparatus of claim 24, wherein said the said wirelessly transmittable combined signals function is an IR signals function.

26. The apparatus of claim 24, wherein said the method of detecting an IR signals function and receiving an IR signals function; and then decodes the said IR signals function into standard computer communication functions of video signals, audio signals, feedback signals for the said remote control device for video camera and feedback signals for the said remote control utility equipment mounting apparatus functions.

27. The apparatus of claim 1, wherein said the said RF signals bundler, receiver & transmitter unit receives video signals and audio signals from the said video camera, control signals for the said remote control device for video camera and control signals for the said remote control utility equipment mounting apparatus.

28. The apparatus of claim 27, wherein said the said RF signals bundler, receiver & transmitter unit groups together and encodes together all the said signals into one combined signal function as the said wirelessly transmittable combined signals function.

29. The apparatus of claim 28, wherein said the said RF signals bundler, receiver & transmitter unit emits the said wirelessly transmittable combined signals function as a wireless RF signal function.

30. The apparatus of claim 28, wherein said the method of grouping together and encoding together video signals and audio signals from the said video camera, control and feedback signals for the said remote control device for video camera and control and feedback signals for the said remote control utility equipment mounting apparatus into one combined signals function and emits this said combined signals function out as a RF (radio frequency) transmittable signals function.

31. The apparatus of claim 1, wherein said the said RF signals converter, receiver & transmitter unit detects and receives the said wirelessly transmittable combined signals function and decodes it into standard computer communication functions of video signals, audio signals, feedback signals for the said remote control device for video camera and feedback signals for the said remote control utility equipment mounting apparatus functions.

32. The apparatus of claim 31, wherein said the said wirelessly transmittable combined signals function is a RF signals function.

33. The apparatus of claim 31, wherein said the method of detecting a RF signals function and receiving a RF signals function; and then decodes the said RF signals function into standard computer communication functions of video signals, audio signals, feedback signals for the said remote control device for video camera and feedback signals for the said remote control utility equipment mounting apparatus functions.

34. The apparatus of claim 1, wherein said the said node station computer can also be a desk top computer, portable computer, handheld PC, PDA, combined PC and telephone unit, and wearable computer, which is defined as a portable computer to be worn on the body of an operator.

35. The apparatus of claim 34, wherein said the said node station computer can also equipped with keyboard, touch screen input device, joy stick, virtual key pad, electronic pointing device and electronic sketching device as computer input device.

36. The apparatus of claim 34, wherein said the said node station computer has the said video on demand computer software installed.

37. The apparatus of claim 36, wherein said the said node station computer communicates to the said video station subassembly by connection to the said IR signals converter, receiver & transmitter unit, which communicates via IR signals emission, detection and receives of the said wirelessly transmittable combined signals functions with the IR signals bundler, receiver & transmitter unit which is connected to the said video station subassembly by the said video and audio signal cable and the said remote-controller cable.

38. The apparatus of claim 37, wherein said the method of a node station computer to communicate to a wireless video station subassembly by connection to an IR signals converter, receiver & transmitter unit, which communicates via IR signals emission, detection and receives of wirelessly transmittable combined signals functions with an IR signals bundler, receiver & transmitter unit which is connected to the said video station subassembly by video and audio signal cable and the said remote-controller cable.

39. The apparatus of claim 36, wherein said the said node station computer communicates to the said video station subassembly by connection to the said RF signals converter, receiver & transmitter unit, which communicates via RF signals emission, detection and receives of the said wirelessly transmittable combined signals functions with the RF signals bundler, receiver & transmitter unit which is connected to the said video station subassembly by the said video and audio signal cable and the said remote-controller cable.

40. The apparatus of claim 39, wherein said the method of a node station computer to communicate to a wireless video station subassembly by connection to the a RF signals converter, receiver & transmitter unit, which communicates via RF signals emission, detection and receives of wirelessly RF transmittable combined signals functions with a RF signals bundler, receiver & transmitter unit which is connected to the said video station subassembly by video and audio signal cable and the said remote-controller cable.

41. The apparatus of claim 36, wherein said the said node station computer communicates to the said video station subassembly by connection to the said signals bundler & converter units, which is connected to the said video station subassembly by the said video and audio signal cable and the said control cable.

42. The apparatus of claim 41, wherein said the said signals bundler & converter units receives the video signals and audio signals from the said video camera, control and feedback signals for the said remote control device for video camera and control and feedback signals for the said remote control utility equipment mounting apparatus; and then converts these signals into standard computer communication functions of video signals, audio signals, feedback signals for the said remote control device for video camera and feedback signals for the said remote control utility equipment mounting apparatus functions.

43. The apparatus of claim 42, wherein said the method of a node station computer communicates to a video station subassembly by connection to a signals bundler & converter units, which is connected to the said video station subassembly by the said video and audio signal cable and the said remote-controller cable.

44. The apparatus of claim 1, wherein said the said Web access computer can also be a desk top computer, portable computer, handheld PC, PDA, combined PC and telephone unit and wearable computer, which is defined as a portable computer to be worn on the body of an operator.

45. The apparatus of claim 44, wherein said the said Web access computer can also be equipped with keyboard, touch screen input device, joy stick, virtual key pad, electronic pointing device and electronic sketching device as computer input device.

46. The apparatus of claim 44, wherein said the said Web access computer has the said video on demand computer software installed.

47. The apparatus of claim 36, wherein said the said node station computer communicates to other node station computers and Web access computers through direct connection, which also includes direct cable connection, fiber-optic cable connection, wireless equipment connection, telephone network connection, mobile phone network connection and satellite phone network connection between node station computer units and web access computer units.

48. The apparatus of claim 36, wherein said the said node station computer communicates to other node station computers and Web access computers through Intranet connection, which also includes Ethernet, local area network (LAN) and mainframe batch computer system.

49. The apparatus of claim 36, wherein said the said node station computer communicates to other node station computers and Web access computers through Internet.

50. The apparatus of claim 1, wherein said the video on demand computer software when installed in a computer will provide the said computer the necessary programmed control functions to allow the said computer to perform as the said node station computer and the said Web access computer.

51. The apparatus of claim 50, wherein said the said node station computer after connected to other node station computers through direct connection, which also includes direct cable connection, fiber-optic cable connection, wireless equipment connection, telephone network connection, mobile phone network connection and satellite phone network connection, Intranet, LAN or Internet can control any video station subassemblies linked to the other node station computers by direct input with computer input devices which also include keyboard, mouse, joystick, trackball, touchscreen, touchpad, virtual keypad, capacitance probe, inductance probe, optical mouse, electronic sketch pad, voice recognition software system and keyboard for visually impaired person to the said node station computer.

52. The apparatus of claim 51, wherein said the said node station computer has multimedia functions to control more than one said video station subassemblies, retrieve data from these video station subassemblies and display the video data on the monitor in multi-display windows simultaneously.

53. The apparatus of claim 51, wherein said the method of using a node station computer after connected to other node station computers through direct connection, which also includes direct cable connection, fiber-optic cable connection, wireless equipment connection, telephone network connection, mobile phone network connection and satellite phone network connection, Intranet, LAN or Internet to control any video station subassemblies, which are connected to the other node station computers by direct input with computer input devices which also include keyboard, mouse, joystick, trackball, touchscreen, touchpad, virtual keypad, capacitance probe, inductance probe, optical mouse, electronic sketch pad, voice recognition software system and keyboard for visually impaired person to the said node station computer.

54. The apparatus of claim 53, wherein said the said node station computer has multimedia functions to control more than one said video station subassemblies, retrieve data from these video station subassemblies and display the video data on the monitor in multi-display windows simultaneously.

55. The apparatus of claim 51, wherein said the said node station computer can allow other node station computers to control the video station subassemblies connected to the said node station computer and retrieve data from the said node station computer.

56. The apparatus of claim 55, wherein said the method of a node station computer to allow other node station computers to control the video station subassemblies, which are connected to the said node station computer and retrieve data from the said node station computer.

57. The apparatus of claim 50, wherein said the said Web access computer after connected to other node station computers through direct connection, which also includes direct cable connection, fiber-optic cable connection, wireless equipment connection, telephone network connection, mobile phone network connection and satellite phone network connection, Intranet, LAN or Internet can control any video station subassemblies linked to the other node station computers, by direct input with computer input device which also includes keyboard, mouse, joystick, trackball, touchscreen, touchpad, virtual keypad, capacitance probe, inductance probe, optical mouse, electronic sketch pad, voice recognition software system and keyboard for visually impaired person to the said Web access computer.

58. The apparatus of claim 57, wherein said the said Web access computer has multimedia functions to control more than one said video station subassemblies, retrieve data from these video station subassemblies and display the video data on the monitor in multi-display windows simultaneously.

59. The apparatus of claim 57, wherein said the method of a Web access computer after connected to other node station computers through direct connection, which also includes direct cable connection, fiber-optic cable connection, wireless equipment connection, telephone network connection, mobile phone network connection and satellite phone network connection, Intranet, LAN or Internet to control any video station subassemblies, which are connected to the other node station computers, by direct input with computer input device which also includes keyboard, mouse, joystick, trackball, touchscreen, touchpad, virtual keypad, capacitance probe, inductance probe, optical mouse, electronic sketch pad, voice recognition software system and keyboard for visually impaired person to the said Web access computer.

60. The apparatus of claim 59, wherein said the said Web access computer has multimedia functions to control more than one said video station subassemblies, retrieve data from these video station subassemblies and display the video data on the monitor in multi-display windows simultaneously.

61. The apparatus of claim 59, wherein said the said Web access computer also includes desk top computer, portable computer, PDA, handheld PC, mobile phone, combination of mobile phone and computer, mobile phone and camera combination unit.

62. The apparatus of claim 50, wherein said the said video on demand computer software allows a node station computer to control the video station subassemblies of other node station computers and retrieve data from these video station subassemblies when all the node station computers are connected by direct connection, which also includes direct cable connection, fiber-optic cable connection, wireless equipment connection, telephone network connection, mobile phone network connection and satellite phone network connection, Intranet, LAN, and/or Internet.

63. The apparatus of claim 62, wherein said the method of using software to allow a computer to remotely control and retrieve data simultaneously from one or more video station subassemblies which are connected to other computers; while all computers are linked together by direct connection, which also includes direct cable connection, fiber-optic cable connection, wireless equipment connection, telephone network connection, mobile phone network connection and satellite phone network connection, Intranet, LAN, and/or Internet.

64. The apparatus of claim 62, wherein said the said data retrieved can be displayed in more than one display windows on the monitor simultaneously.

65. The apparatus of claim 63, wherein said the said method of using software to allow a computer with video station subassemblies connected, to provide functions for other computers to gain control and retrieve data from one or more of its video station subassemblies; while all computers are linked together by direct connection, which also includes direct cable connection, fiber-optic cable connection, wireless equipment connection, telephone network connection, mobile phone network connection and satellite phone network connection, Intranet, LAN, and/or Internet.

66. The apparatus of claim 62, wherein said the said video station subassembly includes a video camera, which also includes camcorder, digital camera, still camera, video camera with still picture capability and mobile phone with picture taking capability; a remote control device for video camera, a remote control utility equipment mounting apparatus, audio and video signals cables and control cable.

67. The apparatus of claim 66, wherein said the said data also includes video data, audio data, control and feedback data of the said remote control device for said video camera and control and feedback data of the said remote control utility equipment mounting apparatus.

68. The apparatus of claim 50, wherein said the method of using this video on demand computer software as one of the control software package in video surveillance system.

69. The apparatus of claim 50, wherein said the method of using this video on demand computer software as one of the control software package in video telephone conferencing system.

70. The apparatus of claim 1, wherein said the said server computer is equipped with the said video on demand server software and is providing data storage, user identity verification and access authorization for the said universal dynamic video on demand surveillance system.

71. A method of using a handheld computer, which includes PDA, handheld PC, wearable PC, combined mobile phone and computer unit, after connected to other node station computers through direct connection, which also includes direct cable connection, fiber-optic cable connection, wireless equipment connection, telephone network connection, mobile phone network connection and satellite phone network connection, Intranet, LAN or Internet to control any cameras, which include video camera, still camera, digital camera and camcorder, which are connected to the other node station computers, and cameras, which also include video cameras, with network connection capability by direct input with computer input device which also include keyboard, mouse, joystick, trackball, touchscreen, touchpad, virtual keypad, capacitance probe, inductance probe, optical mouse, electronic sketch pad, voice recognition software system and keyboard for visually impaired person to the said handheld computer.

72. A method of using a mobile phone, which also includes cellular phone, combination of mobile phone and camera unit, after connected to other node station computers through direct connection, which also includes direct cable connection, fiber-optic cable connection, wireless equipment connection, telephone network connection, mobile phone network connection and satellite phone network connection, Intranet, LAN or Internet to control any cameras, which include video camera, still camera, digital camera and camcorder, which are connected to the other node station computers, and cameras, which include video cameras, with network connection capability by direct input with computer input device which also include keyboard, mouse, joystick, trackball, touchscreen, touchpad, virtual keypad, capacitance probe, inductance probe, optical mouse, electronic sketch pad, voice recognition software system and keyboard for visually impaired person to the said mobile phone unit.
